(19) United States
(12) Patent Application Publication
(10) Pub. No.: US 2021/0138563 A1
(43) Pub. Date: May 13, 2021

(54) CUTTING INSERT AND CUTTING TOOL ASSEMBLY INCLUDING SAME

(71) Applicant: TAEGUTEC LTD., Dalseong-gun (KR)

(72) Inventors: Chang Gyu Park, Dalseong-gun (KR); Su Jin Ryu, Dalseong-gun (KR); Kyu Yeol Baek, Dalseong-gun (KR)

(73) Assignee: TAEGUTEC LTD., Dalseong-gun (KR)

(21) Appl. No.: 16/682,521

(22) Filed: Nov. 13, 2019

(51) Int. Cl. B23C 5/10

(52) U.S. Cl. CPC B23C 5/109; B23C 2200/0416; B23C 2200/083; B23C 2200/086; B23C 2200/361; B23C 2200/123; B23C 2200/128; B23C 2200/162; B23C 2200/28; B23C 2200/121

(57) ABSTRACT

A cutting insert includes: an upper face including a virtual reference surface and an upper inclined surface extending to be inclined upward from the virtual reference surface; a lower face disposed below the upper face and including a lower inclined surface extending to be inclined with respect to the virtual reference surface; and a plurality of side faces connecting the upper face and the lower face. An insert bore is formed to penetrate through the upper face and the lower face along a central axis perpendicular to the virtual reference surface. A major cutting edge is formed at an edge at which the upper inclined surface meets any one side face among the plurality of side faces. A first angle between the side face, on which the major cutting edge is formed, and the upper inclined surface is greater than a second angle between the central axis and the lower inclined surface.

### TECHNICAL FIELD

The present disclosure relates to a cutting insert for milling and a cutting tool assembly including the same.

### BACKGROUND

Milling machines are machine tools used to cut a workpiece which is linearly conveyed through a table by rotating a milling cutter. Various kinds of milling cutters may be mounted in the milling machine so that various kinds of milling such as planar cutting, groove cutting, and cutting can be performed. A milling cutter includes a cutter body and a plurality of cutting inserts mounted in the cutter body. The plurality of cutting inserts are mounted in the cutter body so as to be spaced apart from each other along the circumferential direction around a rotational axis of the cutter body.

The cutter body has appropriate mechanical strength so as to withstand cutting resistance occurring during a process of cutting a workpiece. To this end, the cutter body may have an appropriate diameter. The maximum number of the cutting inserts to be mountable in the cutter body may be increased in proportion to the diameter of the cutter body. In cutter bodies having a same diameter, as the number of cutting inserts mounted in the cutter body is increased, the productivity is increased. That is, the number of cutting inserts mounted in the cutter body is directly proportional to the productivity. In particular, in the case of a cutter body having a very small diameter, the number of cutting inserts is extremely limited. For example, just one or two cutting inserts may be mounted in the cutter body. Thus, if one more cutting inserts may be additionally mounted in the same cutter body having a very small diameter, the productivity may be highly increased.

### SUMMARY

In a conventional milling cutter, when mechanical strength of a cutter body is satisfied, the number of cutting inserts mounted in the cutter body is reduced. Therefore, the productivity may be decreased. Meanwhile, when a large number of the cutting inserts are mounted in the cutter body in order to enhance the productivity, the mechanical strength of the cutter body may be weakened. As described, it is difficult to satisfy both the mechanical strength of the cutter body and enhancement in the productivity.

Various embodiments of the present disclosure improve or solve at least some problems of the conventional milling cutter. To this end, various embodiments of the present disclosure provide a cutting insert and a cutting tool assembly including the same.

Embodiments according to one aspect of the present disclosure is directed to a cutting insert. The cutting insert according to an exemplary embodiment includes: an upper face including a virtual reference surface and an upper inclined surface extending to be inclined upward from the virtual reference surface; a lower face disposed below the upper face and including a lower inclined surface extending to be inclined with respect to the virtual reference surface; and a plurality of side faces connecting the upper face and the lower face. An insert bore is formed to penetrate through the upper face and the lower face along a central axis perpendicular to the virtual reference surface. A major cutting edge is formed at an edge at which the upper inclined surface meets any one side face among the plurality of side faces. A first angle between the side face, on which the major cutting edge is formed, and the upper inclined surface is greater than a second angle between the central axis and the lower inclined surface.

In one embodiment, the side face may include: a first side inclined surface having the first angle with respect to the upper inclined surface; and a second side inclined surface which extends from the first side inclined surface and has a third angle with respect to the upper inclined surface. The third angle is different from the first angle.

In one embodiment, the first angle may range from more than 65 degrees to less than 85 degrees.

In one embodiment, the second angle may range from more than 50 degrees to less than 65 degrees.

In one embodiment, the lower inclined surface may be parallel to the upper inclined surface.

In one embodiment, the lower inclined surface may include a first lower inclined surface and a second lower inclined surface. The first lower inclined surface and the second lower inclined surface may have an included angle that is twice the second angle with respect to the central axis.

In one embodiment, the upper face and the plurality of side faces may be rotationally symmetrical by 180 degrees with respect to the central axis.

In one embodiment, a recess recessed toward the central axis may be formed in the side face on which the major cutting edge is formed.

In one embodiment, the plurality of side faces may include: a first side face on which the major cutting edge is formed; a second side face opposite to the first side face; a third side face which connects the first side face and the second side face; and a fourth side face which connects the first side face and the second side face and is opposite to the third side face.

In one embodiment, the major cutting edge may be formed between the upper inclined surface and at least one of the first side face and the second side face.

In one embodiment, each of the third side face and the fourth side face may be disposed perpendicular to the virtual reference surface.

Embodiments according to one aspect of the present disclosure is directed to a cutting tool assembly. The cutting tool assembly according to an exemplary embodiment includes: a cutter body in which a plurality of insert pockets are formed; a plurality of cutting inserts mounted in the plurality of insert pockets; and a plurality of clamping screws fixing the plurality of cutting inserts to the cutter body. Each of the plurality of cutting inserts may include: an upper face including a virtual reference surface and an upper inclined surface extending to be inclined upward from the virtual reference surface; a lower face disposed below the upper face and including a lower inclined surface extending to be inclined with respect to the virtual reference surface; and a plurality of side faces which connect the upper face and the lower face. An insert bore is formed to pass through the upper face and the lower face along a central axis perpendicular to the virtual reference surface. A major cutting edge is formed at an edge at which the upper inclined surface meets any one side face among the plurality of side faces. A first angle between the side face, on which the major cutting edge is formed, and the upper inclined surface is greater than a second angle between the central axis and the lower inclined surface.

In one embodiment, the insert pocket may include an inclined wall in contact with the lower inclined surface of the lower face.

In one embodiment, the lower inclined surface may include a first lower inclined surface and a second lower inclined surface. The first lower inclined surface and the second lower inclined surface may have an included angle that is twice the second angle with respect to the central axis.

In one embodiment, the inclined wall may include: a first inclined wall in contact with the first lower inclined surface; and a second inclined wall in contact with the second lower inclined surface.

### BRIEF DESCRIPTION OF DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a perspective view illustrating a cutting insert according to one embodiment of the present disclosure.

FIG. 2 is a plan view illustrating the cutting insert shown in FIG. 1.

FIG. 3 is a perspective view illustrating a bottom surface of the cutting insert shown in FIG. 1.

FIG. 4 is a front view illustrating the cutting insert shown in FIG. 1.

FIG. 5 is a cross-sectional view taken along the line V-V shown in FIG. 2.

FIG. 6 is a cross-sectional view taken along the line VI-VI shown in FIG. 2.

FIG. 7 is a perspective view illustrating a cutting insert according to another embodiment of the preset disclosure.

FIG. 8 is a partially cross-sectional view taken along the line VIII-VIII shown in FIG. 7.

FIG. 9 is a perspective view illustrating a cutting tool assembly according to one embodiment of the present disclosure.

FIG. 10 is a partially enlarged view illustrating the cutting tool assembly shown in FIG. 9.

FIG. 11 is a bottom view illustrating the cutting tool assembly shown in FIG. 9.

FIG. 12 is a schematic bottom view illustrating the cutting insert according to one embodiment of the present disclosure.

FIG. 13 is a schematic bottom view illustrating a cutting insert according to a comparative example.

### DETAILED DESCRIPTION

Embodiments of the present disclosure are illustrated for the purpose of explaining the technical idea of the present disclosure. The scope of the rights according to the present disclosure is not limited to the embodiments presented below or the detailed descriptions of such embodiments.

All the technical terms and scientific terms in the present disclosure include meanings or definitions that are commonly understood by those of ordinary skill in the art unless otherwise defined. All terms in the present disclosure are selected for the purpose of describing the present disclosure more clearly, and are not selected to limit the scope of the present disclosure.

As used in the present disclosure, expressions such as “comprising,” “including,” “having,” and the like are to be understood as open-ended terms having the possibility of encompassing other embodiments, unless otherwise mentioned in the phrase or sentence containing such expressions.

The singular expressions that are described in the present disclosure may encompass plural expressions unless otherwise stated, which will be also applied to the singular expressions recited in the claims.

The expressions, such as “first,” “second,” etc., which are shown in various embodiments of the present disclosure, are used to separate a plurality of elements from each other, and are not intended to limit an order or importance of the corresponding elements.

In the present disclosure, the term “radial direction RD” may be defined to mean a direction away from or toward a rotational axis RA of a cutter body of a cutting tool assembly. The term “circumferential direction CD” may be defined to mean a direction surrounding the rotational axis RA.

The directional term “upward,” “upper,” etc., used herein is based on a direction in which an upper face is positioned with respect to a lower face in the accompanying drawings. The directional term “downward,” “lower,” etc., means a direction opposite to the upward or upper direction. A cutting insert shown in the accompanying drawings may be otherwise oriented and the above-described directional terms may be interpreted accordingly.

Hereinafter, embodiments of the present disclosure will be described with reference to the accompanying drawings. In the accompanying drawings, like or relevant components are indicated by like reference numerals. In the following description of embodiments, repeated descriptions of the identical or relevant components will be omitted. However, even if a description of a component is omitted, such a component is not intended to be excluded in an embodiment.

FIG. 1 is a perspective view illustrating a cutting insert according to one embodiment of the present disclosure.

As shown in FIG. 1, a cutting insert 100 according to one embodiment of the present disclosure includes an upper face 110, a lower face 120, and a plurality of side faces 130. The upper face 110, the lower face 120, and the plurality of side faces 130 are distinguished for convenience of description, but these terms do not define absolute components of the cutting insert according to one embodiment. The cutting insert 100 may be manufactured using a hard metal with high hardness formed by sintering a metal carbide powder. For example, the cutting insert 100 may be made of a sintered alloy containing tungsten carbide and cobalt, which have high abrasion resistance.

FIG. 2 is a plan view illustrating the cutting insert shown in FIG. 1.

As shown in FIG. 2, the upper face 110 has a planar shape such as an approximately quadrangular shape. The upper face 110 includes a virtual reference surface 111 and upper inclined surfaces 112. The upper inclined surfaces 112 extend to be inclined upward from the virtual reference surface 111. The virtual reference surface 111 is disposed at a center of the upper face 110. In one embodiment, the virtual reference surface 111 may include a flat (planar) surface, while in other embodiments may be a slightly curved surface. For example, the upper inclined surfaces 112 may be disposed to be opposite to each other at both ends of the virtual reference surface 111. In one embodiment, a concave surface 113 may be formed between the virtual reference surface 111 and the upper inclined surfaces 112 along an approximate length direction of the upper inclined surfaces 112. The concave surface 113 is formed concavely toward the lower face 120 rather than the virtual reference surface 111. Chips generated during cutting of a workpiece may be smoothly discharged along the concave surface 113.

FIG. 3 is a perspective view illustrating a bottom surface of the cutting insert shown in FIG. 1.

As shown in FIG. 3, the lower face 120 is positioned below the upper face 110. The lower face 120 is disposed in contact with a portion of a cutter body (for example, an inclined wall of an insert pocket). Therefore, when the cutter body rotates, the lower face 120 is supported by the cutter body. The lower face 120 includes a lower inclined surface 121 which extends to be inclined with respect to the virtual reference surface 111.

FIG. 4 is a front view illustrating the cutting insert shown in FIG. 1.

As shown in FIG. 4, the plurality of side faces 130 connect the upper face 110 and the lower face 120. Since the upper face 110 has a planar shape such as an approximately quadrangular shape, the plurality of side faces 130 may include four side faces. For example, the plurality of side faces 130 may include side faces disposed perpendicular to the virtual reference surface 111 of the upper face 110 and side faces disposed to be inclined with respect to the virtual reference surface 111.

An insert bore 140 is formed in the cutting insert 100 so as to penetrate through the upper face 110 and the lower face 120 along a central axis CA perpendicular to the virtual reference surface 111. For example, the central axis CA of the insert bore 140 may be defined as a straight line passing through the center of gravity of the upper face 110 and the center of gravity of the lower face 120. The insert bore 140 is formed in a center of the upper face 110 (that is, a center of the virtual reference surface 111). As seen in FIGS. 2, 5 and 6, the central axis CA may be contained in a first vertical plane P1 which passes through the upper and lower faces 110, 120 and two of the side faces 130.

A major cutting edge 150 is formed at an edge of the cutting insert 100 where the upper inclined surfaces 112 meet anyone side face of the plurality of side faces 130. As the cutter body 200 rotates, a workpiece is cut by the major cutting edge 150. The major cutting edge 150 is disposed to protrude outwardly in a radial direction from an outer circumferential surface of the cutter body 200. A shape of the major cutting edge 150 may be determined in accordance with a shape of the workpiece to be machined. For example, the major cutting edge 150 may be continuously or intermittently formed along the edge where the upper inclined surfaces 112 meet the side face 130.

In one embodiment, the side face 130 (e.g., a first side face 131), on which the major cutting edge 150 is formed, may include a first cutting portion 151 and a second cutting portion 152 spaced apart from the first cutting portion 151 along a length direction of the major cutting edge 150. In addition, the major cutting edge 150 may include a first major cutting edge 151a formed on the first cutting portion 151 and a second major cutting edge 152a formed on the second cutting portion 152. A shape of the first cutting portion 151 may be identical to or different from a shape of the second cutting portion 152. The first cutting portion 151 and the second cutting portion 152 may be variously modified and implemented according to a final machined shape of the workpiece. The upper inclined surfaces 112 are formed on the first cutting portion 151 and the second cutting portion 152 so as to be inclined at the same angle with respect to the virtual reference surface 111. In the following description, it may be understood that the term simply described as “major cutting edge 150” without describing the second major cutting edge 152a is referred to as the first major cutting edge 151a.

FIG. 5 is a cross-sectional view taken along the line V-V shown in FIG. 2.

As shown in FIG. 5, a first angle α between the side face 130 on which the major cutting edge 150 is formed and the upper inclined surface 112 is greater than a second angle β between the central axis CA and the lower inclined surface 121. More precisely, the second angle β is formed between the first vertical plane P1 containing the central axis CA and the lower inclined surface 121. Here, the first angle α is an angle between the side face 130 and the upper inclined surface 112 in the first cutting portion 151. Since the first angle α is greater than the second angle β, when the cutting insert 100 is mounted in the cutter body 200, the cutter body 200 may have a maximum core diameter which will be described below. Since the first angle α is greater than the second angle β, the number of the cutting inserts 100 mounted in the cutter body 200 may be increased (for example, the maximum number of the cutting inserts 100 may be mounted). That is, enhancement in the productivity and satisfaction in the mechanical strength of the cutter body can be satisfied at the same time. In addition, the strength of the major cutting edge 150 when the first angle α is greater than the second angle β is greater than the strength of the major cutting edge 150 when the first angle α is less than or equal to the second angle β. Therefore, the strength of the cutting insert 100 may also be improved.

In one embodiment, the side face 130 may include a first side inclined surface 130a and a second side inclined surface 130b. The first side inclined surface 130a has the first angle α with respect to the upper inclined surface 112. The second side inclined surface 130b extends from the first side inclined surface 130a and has a third angle γ with respect to the upper inclined surface 112. The third angle γ is different from the first angle α. In one embodiment, the second side inclined surface 130b may be perpendicular to the virtual reference surface 111 or parallel to the central axis CA of the insert bore 140. The first angle α between the upper inclined surface 112 and the first side inclined surface 130a is greater than the third angle γ between the upper inclined surface 112 and the second side inclined surface 130b. The third angle γ may be understood as an opposite angle of the second angle β of the lower inclined surface 121. When the upper inclined surface 112 is formed to directly meet the second side inclined surface 130b, a major cutting edge formed at an edge between the upper inclined surface 112 and the second side inclined surface 130b is sharpened. The strength of the major cutting edge 150 formed at the edge between the upper inclined surface 112 and the first side inclined surface 130a may be increased by a difference between the first angle α and the third angle 7. That is, the upper inclined surface 112 has the first angle α with respect to the first side inclined surface 130a, thereby reinforcing the strength of the major cutting edge 150.

In one embodiment, the first angle α may range from more than 65 degrees to less than 85 degrees. When the first angle α is less than or equal to 65 degrees, a rake angle of the major cutting edge 150 may be increased. Thus, the strength of the major cutting edge 150 is weakened, thereby resulting in a reduction in durability of the cutting insert 100. When the first angle α is greater than or equal to 85 degrees, the rake angle of the major cutting edge 150 may be reduced. Thus, cutting resistance to be applied to the cutting insert 100 is increased.

In one embodiment, the second angle β may range from more than 50 degrees to less than 65 degrees. When the second angle β is less than or equal to 50 degrees, the rake angle of the major cutting edge 150 may be increased. Thus, the strength of the major cutting edge 150 is weakened, thereby resulting in a reduction in durability of the cutting insert 100. When the second angle β is greater than or equal to 65 degrees, the rake angle of the major cutting edge 150 may be reduced. Thus, the cutting resistance to be applied to the cutting insert 100 is increased. In addition, since the lower inclined surface 121 becomes gentle, the number of the cutting inserts 100 that are mountable in the cutter body 200 having the same diameter may be reduced.

In one embodiment, the lower inclined surface 121 may be parallel to the upper inclined surface 112. When the lower inclined surface 121 is parallel to the upper inclined surface 112, a component force, which is perpendicular to the upper inclined surface 112, among a cutting force acting on the major cutting edge 150 may be stably supported by the inclined wall 231 (see FIG. 10) of the cutter body 200 in contact with the lower inclined surface 121.

FIG. 6 is a cross-sectional view taken along the line VI-VI shown in FIG. 2.

As shown in FIG. 6, a fourth angle δ is formed between the side face 130 and the upper inclined surface 112, and a fifth angle E is formed between the lower inclined surface 121 and the first vertical plane P1 containing the central axis CA of the insert bore 140. Here, the fourth angle δ is an angle between the side face 130 and the upper inclined surface 112 in the second cutting portion 152. A size relationship between the first angle α and the second angle β, an optimum range of the first angle α, and an optimum range of the second angle β shown in FIG. 5 may be identically or similarly applied to a size relationship between the fourth angle δ and the fifth angle ε, an optimum range of the fourth angle δ, and an optimum range of the fifth angle ε shown in FIG. 6. The side face 130 (see FIG. 6) of the second cutting portion 152 does not include a second side inclined face and obliquely extends from the upper inclined surface 112 to the lower inclined surface 121, unlike the side face 130 (see FIG. 5) of the first cutting portion 151.

In one embodiment, the lower inclined surface 121 may include a first lower inclined surface 121a and a second lower inclined surface 121b. The first lower inclined surface 121a and the second lower inclined surface 121b may have an included angle that is twice the second angle β with respect to the central axis CA. The first lower inclined surface 121a and the second lower inclined surface 121b have an approximately V-shaped cross-sectional shape or side shape. As shown in FIGS. 5 and 6, the second angle β may be formed between the first lower inclined surface 121a and the central axis CA, and the second angle β may also be formed between the second lower inclined surface 121b and the central axis CA. For example, the first lower inclined surface 121a and the second lower inclined surface 121b are rotationally symmetrical by 180 degrees with respect to the central axis CA. That is, referring to FIGS. 5 and 6, the first lower inclined surface 121a and the second lower inclined surface 121b are mirror-symmetrical with respect to the central axis CA. Therefore, when the cutting insert 100 is initially mounted in the cutter body 200, the cutting insert 100 may be quickly mounted without regard to directionality of the cutting insert 100. In addition, since the first lower inclined surface 121a and the second lower inclined surface 121b are disposed to have the same angle with respect to the central axis CA, it is possible to effectively suppress or prevent the cutting insert 100 from moving in an inner radial direction or outer radial direction when the workpiece is cut.

In one embodiment, the upper face 110 and the plurality of side faces 130 may be rotationally symmetrical by 180 degrees with respect to the central axis CA. When the upper face 110 and the plurality of side faces 130 are rotationally symmetrical by 180 degrees with respect to the central axis CA, two first cutting portions 151 and two second cutting portions 152 are formed in one cutting insert 100. Therefore, when one first cutting portion 151 and one second cutting portion 152 are worn out, the remaining first cutting portion 151 and the remaining second cutting portion 152 may be used for cutting. Therefore, costs for cutting a workpiece may be reduced.

In one embodiment, the plurality of side faces 130 may include the first side face 131 on which the major cutting edge is formed, a second side face 132 opposite to the first side face 131, a third side face 133 which connects the first side face 131 and the second side face 132, and a fourth side face 134 which connects the first side face 131 and the second side face 132 and is opposite to the third side face 133. The second side face 132 is rotationally symmetrical to the first side face 131 by 180 degrees with respect to the central axis CA. Therefore, detailed descriptions of an upper inclined surface and a major cutting edge formed on the second side face 132 will be omitted. The third side face 133 is shown in FIG. 4 and has an exterior shape similar to that of the cross-sectional view shown in FIG. 5. In addition, the fourth side face 134 is rotationally symmetrical to the third side face 133 by 180 degrees with respect to the central axis CA.

The opposing first and second side faces 131, 132 are “cutting side faces” since major cutting edges are formed at their intersections with the upper inclined surfaces 112, while the opposing third and fourth side faces 133, 134 are “non-cutting side faces” since major cutting edges are not formed at their intersections with the upper face 110.

As seen in FIGS. 2, 5 and 6, the first vertical plane P1 passes through the upper and lower faces 110, 120 and is perpendicular to the third and fourth non-cutting side faces 133, 134. As seen from FIGS. 4-6, the insert's lower face 120 is V-shaped for a majority, if not substantially all, of the depth of the insert, i.e., in a direction generally parallel to the cutting side faces 131, 132.

In one embodiment, the major cutting edge 150 may be formed between the upper inclined surface 112 and at least one of the first side face 131 and the second side face 132. That is, the major cutting edge 150 may be formed between the upper inclined surface 112 and the first side face 131 or between the upper inclined surface 112 and the second side face 132. In addition, the major cutting edge 150 may be formed between the upper inclined surface 112 and the first side face 131 and between the upper inclined surface 112 and the second side face 132.

In one embodiment, each of the third side face 133 and the fourth side face 134 may be disposed perpendicular to the virtual reference surface 111. Accordingly, the cutting insert 100 may be mounted in the cutter body 200 such that the third side face 133 or the fourth side face 134 is coplanar with a bottom surface 210 of the cutter body 200.

In one embodiment, a recess 135 may be formed toward the central axis CA in the side face 130 on which the major cutting edge 150 is formed. That is, the recess 135 may be formed in at least one of the first side face 131 and the second side face 132. For example, the recess 135 may be located between the first cutting portion 151 and the second cutting portion 152. The recess 135 may have various shapes, such as various polygonal, semi-elliptic, and semicircular shapes in accordance with a final machined shape of the workpiece. Thus, the recess 135 may be provided with one more recess cutting edges 160 configured to mill a protrusion having a predetermined shape on the workpiece. In a similar manner, the first and second major cutting edges 151a, 152a formed on either side of the recess 135 may be configured to mill predetermined surface contours on the workpiece. The first and second major cutting edges 151a, 152a may differ from one another in shape and therefore be configured to mill differently shaped surface contours on either side of the projection. It is understood that the projection and the surface contours may be simultaneously milled in a single milling operation.

FIG. 7 is a perspective view illustrating a cutting insert according to another embodiment of the preset disclosure. FIG. 8 is a partially cross-sectional view taken along the line VII-VIII shown in FIG. 7.

As shown in FIGS. 7 and 8, the cutting insert 100a according to another embodiment of the present disclosure may not include any recesses formed in the side face 130 on which the major cutting edge 150 is formed. That is, no recess is formed in the first side face 131 and the second side face 132. For example, the first cutting portion 151 is directly connected to the second cutting portion 152 the without any recess. In this embodiment, the size relationship between the first angle α and the second angle β, the optimum range of the first angle α, and the optimum range of the second angle β shown in FIG. 5 may be identically or similarly applied to the cutting insert 100a shown in FIG. 8.

FIG. 9 is a perspective view illustrating a cutting tool assembly according to one embodiment of the present disclosure.

As shown in FIG. 9, a cutting tool assembly 500 according to one embodiment of the present disclosure includes a cutter body 200, a plurality of cutting inserts 100, and a plurality of clamping screws 300. Each of the plurality of cutting inserts 100 according to this embodiment may be formed to be identical or similar to the cutting insert 100 shown in FIGS. 1 to 6, and thus, detailed descriptions of each of the plurality of cutting inserts 100 will be omitted. Therefore, the cutter body 200 and the plurality of clamping screws 300 will be mainly described below.

FIG. 10 is a partially enlarged view illustrating the cutting tool assembly shown in FIG. 9 and is a view illustrating a state in which one cutting insert and one clamping screw are disassembled from the cutter body.

As shown in FIG. 10, the cutter body 200 may include a bottom surface 210 and a cylindrical portion 220. The bottom surface 210 is disposed approximately parallel to a rotational axis RA of the cutter body 200. The cylindrical portion 220 extends from the bottom surface 210 in a vertical direction. A rotary driving part of a cutting tool is disposed at aside opposite to the bottom surface 210 along the rotational axis RA of the cutter body 200. The rotary driving part may be coupled directly to the cutter body 200 or coupled indirectly through another member. A plurality of insert pockets 230 are formed in the cutter body 200. Each of the plurality of insert pockets 230 is formed in the bottom surface 210 and the cylindrical portion 220 so as to be concavely recessed throughout the bottom surface 210 and the cylindrical portion 220.

As described in detail with reference to one embodiment shown in FIGS. 1 to 6, each of the plurality of cutting inserts 100 includes the upper face 110, the lower face 120, and the plurality of side faces 130. The insert bore 140 and the major cutting edges 150 are formed in each of the plurality of cutting inserts 100. The plurality of cutting inserts 100 are mounted in the cutter body 200 such that one side face (for example, the third side face 133 or the fourth side face 134) is coplanar with the bottom surface 210 of the cutter body 200.

The clamping screw 300 fixes each of the plurality of cutting inserts 100 to the cutter body 200. A screw hole 232 is formed in the insert pocket 230 for screw-coupling with the clamping screw 300. A central axis of the screw hole 232 matches with the central axis CA of the insert bore 140 and a rotational axis of the clamping screw 300. After the cutting insert 100 is placed in the insert pocket 230, the clamping screw 300 penetrates through the insert bore 140 of the cutting insert 100 and is screw-coupled to the cutter body 200. The clamping screw 300 is disposed perpendicular to the virtual reference surface 111 of the cutting insert 100.

FIG. 11 is a bottom view illustrating the cutting tool assembly shown in FIG. 9.

As shown in FIG. 11, in one embodiment, the insert pocket 230 may include the inclined wall 231 in contact with the lower inclined surface 121 of the lower face 120. In one embodiment, the lower inclined surface 121 may include the first lower inclined surface 121a and the second lower inclined surface 121b. The first lower inclined surface 121a and the second lower inclined surface 121b may have an included angle that is twice the second angle β with respect to the central axis CA. In the present embodiment, the inclined wall 231 may include a first inclined wall 231a in contact with the first lower inclined surface 121a and a second inclined wall 231b in contact with the second lower inclined surface 121b. The first inclined wall 231a and the second inclined wall 231b forming a V-shaped concave portion are engaged with the first lower inclined surface 121a and the second lower inclined surface 121b forming a V-shaped convex portion. Due to the V-shaped concave and convex portions being engaged with each other, the cutting insert 100 may be stably supported by the insert pocket 230 of the cutter body 200. As a result, even though cutting resistance acts on the cutting insert 100 due to cutting of the workpiece, it is possible to suppress or prevent the cutting insert 100 from moving in an outer radial direction or inner radial direction with respect to the rotational axis RA.

FIG. 12 is a schematic bottom view illustrating the cutting insert according to one embodiment of the present disclosure. FIG. 13 is a schematic bottom view illustrating a cutting insert according to a comparative example. In FIGS. 12 and 13, for clarity of illustration, detailed configurations are omitted, and the cutting insert according to one embodiment and the cutting insert according to the comparative example are shown as an outline.

FIG. 12 illustrates an example in which the cutting insert 100 according to one embodiment is mounted in the cutter body 200 having a diameter D through the clamping screw 300. FIG. 13 illustrates an example in which the cutting insert 10 according to the comparative example is disposed in a cutter body 400 having the same diameter D as the diameter D of the cutter body 200 through the clamping screw 300. As shown in FIG. 12, the lower face 120 of the cutting insert 100 according to one embodiment includes the lower inclined surface 121. As shown in FIG. 13, a lower face 12 of the cutting insert 10 according to the comparative example does not include an inclined surface. A radius R1 from the rotational axis RA to the main cutting edge 151a in the cutting insert 100 according to one embodiment is the same as a radius R2 from the rotational axis RA to the main cutting edge 11 in the cutting insert 10 according to the comparative example. As shown in FIG. 13, when the lower face 12 of the cutting insert 10 does not include the inclined surface, the cutting insert 10 is coupled to the cutter body 200 so as to be close to a rotational axis RA. Therefore, a core diameter D1 according to one embodiment is greater than a core diameter D2 according to the comparative example. Here, the core diameter refers to a central region of the cutter body that does not overlap the cutting insert on the bottom surface of the cutting tool assembly in a state in which the cutting insert is mounted in the cutter body. In the cutter body having the same diameter, as the core diameter is increased, the strength of the cutter body for stably supporting the cutting insert is increased. As a result, the mechanical strength of the cutter body according to one embodiment is higher than the mechanical strength of the cutter body according to the comparative example.

In addition, in FIG. 13, in order to avoid interference between one cutting insert and another adjacent cutting insert and satisfy minimum strength for supporting the cutting insert 10, the number of the cutting inserts 10 mounted in the cutter body 200 is inevitably limited. Therefore, the maximum number of the cutting inserts 100 mounted in the cutter body 200 according to one embodiment is greater than the maximum number of the cutting inserts 10 mounted in the cutter body 200 according to the comparative example. Therefore, according to one embodiment of the present disclosure, it is possible to enhance the productivity.

According to the cutting insert and the cutting tool assembly according to one embodiment, the lower face includes a lower inclined surface, and the first angle between the side face on which the major cutting edge of the cutting insert is formed and the upper inclined surface is greater than the second angle between the first vertical plane containing the central axis and the lower inclined surface. Therefore, in the cutter body having the same diameter, not only the number of cutting inserts mounted in the cutter body may be increased, but also a maximum core diameter of the cutter body can be obtained. As a result, not only the productivity can be enhanced but also the mechanical strength of the cutter body can be satisfied. That is, enhancement in the productivity and satisfaction in the mechanical strength of the cutter body can be satisfied at the same time.

Although the present disclosure has been described in relation to some embodiments, it should be noted that there may be various modifications and changes without departing from the spirit and scope of the present disclosure, which can be understood by those skilled in the art. In addition, such modifications and changes should be construed to belong to the scope of the claims appended herein.

1. A cutting insert comprising:
an upper face including a virtual reference surface and an upper inclined surface extending to be inclined upward from the virtual reference surface;
a lower face disposed below the upper face and including a lower inclined surface extending to be inclined with respect to the virtual reference surface; and
a plurality of side faces connecting the upper face and the lower face,
wherein an insert bore is formed to penetrate through the upper face and the lower face along a central axis perpendicular to the virtual reference surface,
wherein a major cutting edge is formed at an edge at which the upper inclined surface meets any one side face among the plurality of side faces, and
wherein a first angle between the side face, on which the major cutting edge is formed, and the upper inclined surface is greater than a second angle between the central axis and the lower inclined surface.

2. The cutting insert of claim 1, wherein the side face includes:
a first side inclined surface having the first angle with respect to the upper inclined surface; and
a second side inclined surface which extends from the first side inclined surface and has a third angle with respect to the upper inclined surface, and
wherein the third angle is different from the first angle.

3. The cutting insert of claim 1, wherein the first angle ranges from more than 65 degrees to less than 85 degrees.

4. The cutting insert of claim 1, wherein the second angle ranges from more than 50 degrees to less than 65 degrees.

5. The cutting insert of claim 1, wherein the lower inclined surface is parallel to the upper inclined surface.

6. The cutting insert of claim 1, wherein the lower inclined surface includes a first lower inclined surface and a second lower inclined surface, and
wherein the first lower inclined surface and the second lower inclined surface have an included angle that is twice the second angle with respect to the central axis.

7. The cutting insert of claim 1, wherein the upper face and the plurality of side faces are rotationally symmetrical by 180 degrees with respect to the central axis.

8. The cutting insert of claim 1, wherein a recess recessed toward the central axis is formed in the side face on which the major cutting edge is formed.

9. The cutting insert of claim 1, wherein the plurality of side faces include:
a first side face on which the major cutting edge is formed;
a second side face opposite to the first side face;
a third side face which connects the first side face and the second side face; and
a fourth side face which connects the first side face and the second side face and is opposite to the third side face.

10. The cutting insert of claim 9, wherein the major cutting edge is formed between the upper inclined surface and at least one of the first side face and the second side face.

11. The cutting insert of claim 9, wherein each of the third side face and the fourth side face is disposed perpendicular to the virtual reference surface.

12. A cutting tool assembly comprising:
a cutter body in which a plurality of insert pockets are formed;
a plurality of cutting inserts mounted in the plurality of insert pockets; and
a plurality of clamping screws fixing the plurality of cutting inserts to the cutter body,
wherein each of the plurality of cutting inserts includes:
an upper face including a virtual reference surface and an upper inclined surface extending to be inclined upward from the virtual reference surface;
a lower face disposed below the upper face and including a lower inclined surface extending to be inclined with respect to the virtual reference surface; and
a plurality of side faces which connect the upper face and the lower face,
wherein an insert bore is formed to pass through the upper face and the lower face along a central axis perpendicular to the virtual reference surface,
wherein a major cutting edge is formed at an edge at which the upper inclined surface meets any one side face among the plurality of side faces, and
wherein a first angle between the side face, on which the major cutting edge is formed, and the upper inclined surface is greater than a second angle between the central axis and the lower inclined surface.

13. The cutting tool assembly of claim 12, wherein the insert pocket includes an inclined wall in contact with the lower inclined surface of the lower face.

14. The cutting tool assembly of claim 13, wherein the lower inclined surface includes a first lower inclined surface and a second lower inclined surface, and
wherein the first lower inclined surface and the second lower inclined surface have an included angle that is twice the second angle with respect to the central axis.

15. The cutting tool assembly of claim 14, wherein the inclined wall includes:
a first inclined wall in contact with the first lower inclined surface; and
a second inclined wall in contact with the second lower inclined surface.

16. A cutting insert comprising:
an upper face including a virtual reference surface and first and second upper inclined surfaces extending to be inclined upward from opposite sides of the virtual reference surface;
a V-shaped lower face disposed below the upper face and including first and second lower inclined surfaces extending to be inclined upward and outward in opposite directions;
a plurality of side faces connecting the upper face and the lower face, the plurality of side faces including opposing first and second cutting side faces, and opposing third and fourth non-cutting side faces;
an insert bore passing through the upper face and the lower face along a central axis which is perpendicular to the virtual reference surface;
a first vertical plane containing the central axis, passing through the upper and lower faces and perpendicular to the opposing third and fourth non-cutting side faces;
a major cutting edge formed at the edge where the first upper inclined surface meets the first cutting side face, wherein:
a first angle between the first cutting side face and the first upper inclined surface is greater than a second angle between the first vertical plane and the first lower inclined surface.

17. The cutting insert of claim 16, wherein:
the first angle ranges from more than 65 degrees to less than 85 degrees; and
the second angle ranges from more than 50 degrees to less than 65 degrees.

18. The cutting insert of claim 16, wherein:
the cutting insert has 180° rotational symmetry about the central axis.

19. The cutting insert of claim 16, wherein a recess recessed toward the central axis is formed in the first cutting side face, the recess dividing the major cutting edge into a first major cutting edge spaced apart from a second major cutting edge.

20. The cutting insert of claim 19, wherein:
the recess comprises one or more recess cutting edges configured to mill a protrusion having a predetermined shape on a workpiece; and
the spaced apart first and second major cutting edges formed on either side of the recess differ from one another in shape and are configured to simultaneously mill differently shaped surface contours on either side of the protrusion, on that workpiece.
